(19) United States
(12) Patent Application Publication
(10) Pub. No.: US 2025/0247249 A1
(43) Pub. Date: Jul. 31, 2025

(54) DEVICE AND METHOD FOR EXTRACTING AND STRUCTURING VERFIABLE PERSONAL DATA FROM USER INPUT AND OUTPUT DATA CAPTURED ON A DEVICE BASED ON A MULTI-MODAL AND LANGUAGE AI MODEL

(71) Applicant: BLOCKCHAIN LABS INC., Seoul (KR)

(72) Inventors: Yong Tae KIM, Seoul (KR); Byung Wan LIM, Seoul (KR); Jong Hoon PARK, Hanam-si (KR)

(73) Assignee: BLOCKCHAIN LABS INC., Seoul (KR)

(21) Appl. No.: 19/041,098

(22) Filed: Jan. 30, 2025

(30) Foreign Application Priority Data
Jan. 31, 2024 (KR) 10-2024-0014525

(51) Int. Cl. H04L 9/32; G06F 40/40; H04L 9/14

(52) U.S. Cl. CPC H04L 9/3247; G06F 40/40; H04L 9/14

(57) ABSTRACT

There is disclosed an electronic device comprising a memory for storing personal data and at least one processor, wherein the at least one processor is configured to: when detecting a target action during execution of a target application, capture user input/output data generated according to the target action, transmit the user input/output data to a multi-modal AI model connected to the electronic device through a network, receive text data generated based on the user input/output data from the multi-modal AI model, transmit the text data to an AI language model connected to the electronic device, receive final data having the same format as the personal data from the AI language model, and merge and store the final data with the personal data. In addition to the above, various embodiments identified through the specification are possible.

### CROSS-REFERENCE TO RELATED APPLICATION

This application claims priority to Korean Patent Application No. 10-2024-0014525 filed on Jan. 31, 2024, and all the benefits accruing therefrom under 35 U.S.C. § 119, the contents of which are incorporated by reference in their entirety.

### BACKGROUND

The embodiments disclosed in this document relate to technology for extracting and collecting data on a user device.

### SUMMARY

Individuals use various applications provided by different service operators using personal electronic devices such as smartphones. The data generated during this process is owned and managed by companies (service providers) that operate the services, preventing individuals from having ownership or access rights to that data.

Meanwhile, recently, the performance of Large Language Models (LLM) has been developing exponentially, and multi-modal AI Models that handle various types of data including not only text but also images and videos are being commercialized. As a result, the barriers to entry for such AI models are lowering, and various new attempts to utilize them are being made.

While individuals continuously generate data while using personal electronic devices, they essentially have no opportunity to utilize the data they create. Since the created data is stored by service providers, individuals cannot directly own the data unless they download it from the service providers. Various embodiments disclosed in this document provide methods for extracting and managing personal data from raw data generated at the device level using artificial intelligence models, separate from the data managed by service operators.

Additionally, since data owned by individuals is at risk of forgery and alteration, measures to verify the integrity of the data are necessary. Therefore, we aim to distribute data directly generated by individuals in a verifiable form. Various embodiments disclosed in this document provide methods for generating data and data certificates at the operating system level of the user device to enable verification through blockchain networks.

According to the embodiments disclosed in this document, an electronic device comprises a memory for storing personal data and at least one processor, wherein the at least one processor is configured to: when detecting a target action during execution of a target application, capture user input/output data generated according to the target action, transmit the user input/output data to a multi-modal AI model connected to the electronic device through a network, receive text data generated based on the user input/output data from the multi-modal AI model, transmit the text data to an AI language model connected to the electronic device, receive final data having the same format as the personal data from the AI language model, and merge and store the final data with the personal data.

According to the embodiments disclosed in this document, data can be generated at the user device level, and user devices such as smartphones can become new data sources that did not previously exist. Furthermore, such data can become trustworthy data guaranteed by the manufacturer of the user device. In addition, various effects that can be directly or indirectly identified through this document may be provided.

### BRIEF DESCRIPTION OF THE DRAWINGS

FIG. 1 is a conceptual diagram for explaining a method of extracting and structuring personal data from data captured on an electronic device according to an embodiment.

FIG. 2 is a block diagram of an electronic device according to an embodiment.

FIG. 3 is a flowchart of a method for extracting personal data by an electronic device according to an embodiment.

FIG. 4 is an example of screen image data captured by an electronic device.

FIG. 5 is an example of personal data extracted from the screen image data captured in FIG. 4.

With respect to the description of the drawings, the same or similar reference signs may be used for the same or similar elements.

### DETAILED DESCRIPTION OF EMBODIMENTS

Hereinafter, various embodiments of the present disclosure will be described with reference to the accompanying drawings. However, this is not intended to limit the present disclosure to the specific embodiments, and it is to be construed to include various modifications, equivalents, and/or alternatives of embodiments of the present disclosure.

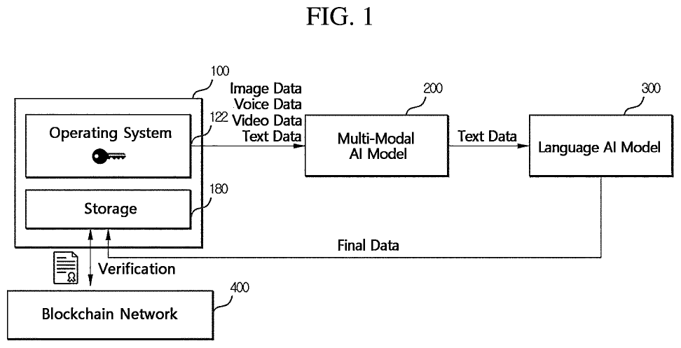

FIG. 1 is a conceptual diagram for explaining a method of extracting and structuring personal data from data captured on an electronic device 100 according to an embodiment. According to an embodiment, the electronic device 100 owned and used by an individual can be understood as a computing device such as a smartphone, PC, tablet PC, or the like.

The electronic device 100 can convert and structure data input or output by the user of the electronic device 100 into verifiable personal data using artificial intelligence models. The data input by the user may include touch input data, keyboard input data, and voice input data, and the data output by the user may include image (hereinafter, screen image) or video (hereinafter, screen video) data displayed through the display of the electronic device 100, and voice output data. Hereinafter, data input or output by the user is referred to as user input/output data.

When an application installed on the electronic device 100 is executed and a user action (e.g., search, selection input, voice input, voice output, video playback) is performed on the executed application, the electronic device 100 can capture the user input/output data when the action is performed and store the user input/output data in the storage 180 of the electronic device 100.

In various embodiments, the electronic device 100 may also use services provided through a web browser (hereinafter, web services) rather than applications. In this case, when accessing a specific web browser address and when user action occurs, the electronic device 100 may also capture user input/output data. While the following description is based on when an application is executed, the electronic device 100 can operate similarly when a web service is executed through a web browser.

The storage 180 of the electronic device 100 can be understood as storage space for storing data extracted from user input/output data (hereinafter, personal data). The storage 180 may have memory 120 within the electronic device 100 or a cloud device (not shown) that operates in conjunction with the electronic device 100 through a network. The personal data may have a structured format.

The electronic device 100 can transmit the captured user input/output data to a multi-modal AI model 200. The multi-modal AI model 200 can be understood as an artificial intelligence model capable of processing various types of data such as text, images, video, and voice, and describe them in natural language. The electronic device 100 can transmit user input/output data to the multi-modal AI model 200 connected to the electronic device 100 through a network.

The electronic device 100 can receive text data corresponding to the user input/output data from the multi-modal AI model 200. This text data can be understood as natural language information (hereinafter, descriptive information) that describes or explains the user input/output data captured by the electronic device 100. The electronic device 100 can use the language AI model 300 to convert the received text data into a data structure with the same format as the personal data stored in storage 180. The electronic device 100 can transmit the text data to the language AI model 300 and receive final data in a structured format from the language AI model 300. The electronic device 100 can integrate and store the final data with the personal data in storage 180.

According to various embodiments, the language AI model 300 may include a Large Language Model (hereinafter LLM) or a Small Language Model (hereinafter SLM). When adopting LLM as the language AI model 300, the electronic device 100 can connect to a predetermined language AI model 300 through a network and transmit text data. When adopting SLM as the language AI model 300, the electronic device 100 can transmit text data to the language AI model 300 installed within the electronic device 100. It is assumed that the SLM as the language AI model 300 is an on-device model.

The electronic device 100 can generate a Decentralized Identifier (hereinafter DID) of the blockchain network 400 and a private key/public key (account of the blockchain network 400) associated with the DID. The electronic device 100 can generate and operate the DID according to the standard specifications of W3C (World Wide Web Consortium), a web standardization organization. The electronic device 100 can generate a pair of private and public keys based on the ECDSA encryption algorithm using the secp256k1 curve, the EdDSA algorithm using the Ed25519 curve, or the RSA encryption algorithm. Additionally, the electronic device 100 can be implemented to generate electronic signatures based on the private key. In one embodiment, the public key can be used as the DID, or the electronic device 100 can generate a DID separately from the public key.

In various embodiments, the blockchain network 400 may include at least one blockchain network among known public blockchain networks. The blockchain network 400 may include a DID document (not shown). The DID document can store the DID of the electronic device 100, the public key corresponding to the DID, and information associated with the DID.

The electronic device 100 can generate a data certificate for the extracted personal data. In one embodiment, the data certificate can be generated in the form of Verifiable Credentials (hereinafter VC) according to W3C standardization specifications. The data certificate may include the DID of the electronic device 100 and the electronic signature of the electronic device 100. The electronic device 100 can perform electronic signing on the generated final data based on the private key associated with the DID. Anyone can verify the owner and integrity of the final data through the blockchain network 400.

The operations and functions of the electronic device 100 described through FIG. 1 can be implemented by the operating system 122 installed on the electronic device 100 and performed according to the execution of the operating system 122. For example, detecting the specific application running on the electronic device 100 and detecting specific actions performed on that application can be performed at the operating system 122 level. In this case, the functions of the electronic device 100 can be implemented through the operating system 122.

Meanwhile, the operating system 122 of the electronic device 100 is installed on the electronic device 100 by the manufacturer. Therefore, personal data is not arbitrarily created by the user but is automatically generated according to the manufacturer's design and implementation. Consequently, personal data becomes trustworthy data guaranteed by the manufacturer.

In one embodiment, the DID of the electronic device 100 can be generated at the operating system 122 level when the electronic device 100 is manufactured. In various embodiments, electronic devices shipped from the manufacturer can each have their unique DIDs. Additionally, the DID document of the blockchain network 400 where the DID is stored can contain information related to the manufacturer of the electronic device 100 (e.g., manufacturer name, model name of the electronic device 100, manufacturing date). Therefore, anyone can verify which manufacturer created the DID by retrieving the DID document based on the DID. Furthermore, since the data certificate for personal data includes an electronic signature based on the DID of the electronic device 100, anyone can verify through signature verification that the personal data was generated by the manufacturer of the electronic device 100 and is trustworthy data.

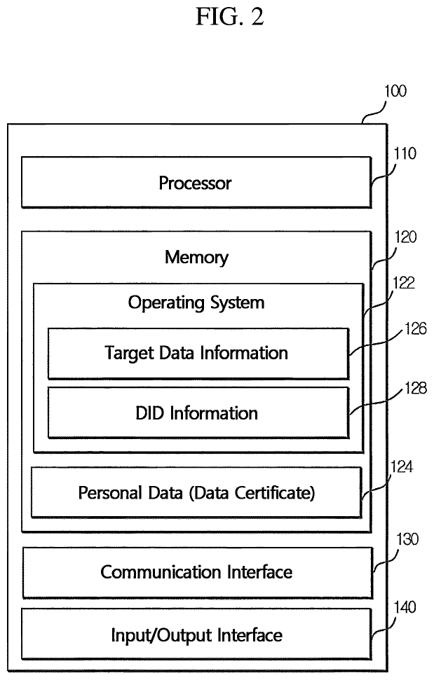

FIG. 2 is a block diagram of an electronic device 100 according to an embodiment. The electronic device 100 may include a processor 110, memory 120, communication interface 130, and input/output interface 140. The processor 110 may include one or more processors for controlling the overall operation of the electronic device 100. The processor 110 can be configured to execute instructions stored in memory 120 while being operably connected to the memory 120.

The memory 120 may include an operating system 122. In various embodiments, at least part of the electronic device 100's operation for extracting and structuring personal data from user input/output data captured on the electronic device 100 can be implemented by the operating system 122. The processor 110 of the electronic device 100 can perform said function according to an embodiment of the present invention by executing the operating system 122 stored in memory 120.

The operating system 122 can store target data information 126 and DID information 128. The target data information 126 may include target application and target action information. Target applications can be understood as a list of target applications for capturing user input/output data. The electronic device 100 can capture user input/output data when a target application is executed, and specific actions are performed on the target application. Such specific actions for target applications are referred to as target actions. Target actions may include, for example, selection inputs for search/options/buttons, voice input through microphone, voice output through speaker, video playback, etc. In various embodiments, the target data information 126 may further include target addresses for web services and corresponding target action information.

In various embodiments, target applications and target actions can be predetermined by the user. The user can be understood as the individual who owns the electronic device 100. The user can pre-determine applications (e.g., shopping applications) from which they want to obtain personal data, and further pre-determine target actions (e.g., search, purchase decision) in those applications. For example, users can obtain personal data in their needed fields and create AI models trained on their data based on it. Or, if there are entities wanting to purchase specific data, users can obtain personal data tailored to those purchase requests. The target data information 126 may include a list of applications and actions pre-determined by the user.

In various embodiments, users can select target applications and target actions through an interface provided by the operating system 122. The electronic device 100 can determine when to capture user input/output data according to the pre-configured target data information 126 and obtain user input/output data at that time.

In various embodiments, the target data information 126 may further include information about the types of user input/output data to capture for target applications and target actions. For example, data to be captured for a search action in a shopping application can be determined as screen image data and keyboard input data.

In one embodiment, the DID information 128 may include blockchain account (public key/private key) and DID generated by the electronic device 100. The electronic device 100 can generate an electronic signature and data certificates based on the DID information 128.

The memory 120 may include personal data 124. The personal data 124 can be understood as data in a structed format extracted from user input/output data captured on the electronic device 100. In various embodiments, personal data can be stored and managed as a Personal Knowledge Graph (hereinafter, PKG). Data constituting the PKG can be implemented in compliance with semantic web technology standards (RDF, JSON-LD, OWL, SPARQL). Since personal data 124 is structured and stored in PKG format, accurate meaning-based data search becomes possible on the electronic device 100. Through this search functionality, personal data 124 can be easily utilized. Furthermore, since the storage, management, and search of personal data 124 can be performed based on standardized structures, interoperability can be ensured even when personal data 124 is distributed to third parties. Personal data 124 can be stored not only in the memory 120 of the electronic device 100 but also in a cloud device operating in conjunction with the electronic device 100 through a network. The electronic device 100 can have both the memory 120 and cloud device memory as storage space.

The electronic device 100 can communicate with the multi-modal AI model 200, language AI model 300, and blockchain network 400 through the communication interface 130.

The input/output interface 140 may include all interfaces for inputting data and outputting data. For example, the input/output interface 140 may include a display for outputting screen images/videos, a touchpad for receiving touch input, a speaker for outputting voice, a microphone for receiving voice input, a keyboard for receiving text input, a mouse for receiving selection input, etc. In one embodiment, the electronic device 100 can be configured to capture data input or output through the input/output interface 140 at the operating system level.

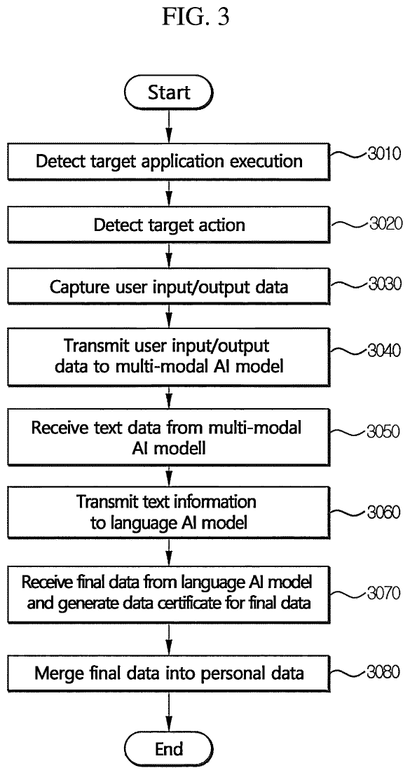

FIG. 3 is a flowchart of a method for extracting personal data by an electronic device 100 according to an embodiment.

The electronic device 100 can detect the execution of a target application (3010), and when detecting a target action during the execution of the target application (3020), capture user input/output data generated according to the target action (3030). For example, for target applications and target actions of operations 3010 and 3020, screen image capture can be preset to be performed.

In various embodiments, the electronic device 100 can capture predetermined types of user input/output data among the user input/output data occurring according to the target action.

In various embodiments, the electronic device 100 can capture screen video data during the execution of the target application and target action, capture voice data input or output during the execution of the target application and target action, or capture touch/keyboard input data generated during the execution of the target application and target action, according to what is preset in the target data information 126.

In various embodiments, a plurality of user input/output data can be set for target applications and target actions. The electronic device 100 can capture the plurality of user input/output data when the target action is executed and transmit the plurality of user input/output data to the multi-modal AI model 200. For example, if screen video data, voice input data, and voice output data are set as data to be captured for a call action in a video call application, the electronic device 100 can capture screen video data, voice input data, and voice output data during the video call.

In various embodiments, the timing or duration for capturing data can be preset for target applications and target actions. The capture timing can be determined based on the start/end time of the target action or user input occurring in relation to the target action. For example, the capture timing for a search action in a web browser application can be preset to when touch input for the search button is received or when keyboard input for enter is received. In another example, the capture duration for a call action in a call application can be preset to capture voice input and output data during the time from the start to the end of the call action.

The electronic device 100 can transmit the user input/output data to the multi-modal AI model 200 connected to the electronic device 100 through a network (3040), and the electronic device 100 can receive text data generated based on the screen image from the multi-modal AI model 200 (3050). For example, when user input/output data is screen image data, the text data can be understood as descriptive information inferred by the multi-modal AI model 200 from text and image objects such as buttons/icons included in the screen image data.

In operation 3040 according to one embodiment, the electronic device 100 can transmit the user input/output data and an instruction to the multi-modal AI model 200. The instruction can be understood as a command (prompt) requesting the multi-modal AI model 200 to describe the user input/output data. The electronic device 100 can generate instructions requesting a description of the user input/output data. The instruction may include information about the target application executed in operation 3010 and the target action detected in operation 3020. The multi-modal AI model 200 can generate text information in natural language form describing the user input/output data based on the target application information, target action information and the instruction.

The electronic device 100 can transmit the text data to the AI language model 300 connected to the electronic device 100 through a network. In various embodiments, the AI language model 300 can be either a LLM operated by a third party or an on-device AI model (SLM) running within the electronic device 100.

The electronic device 100 receives final data from the AI language model 300, and can generate a data certificate by performing an electronic signature based on the private key associated with the DID of the electronic device 100 on the final data (3070). The data certificate may include the electronic signature and the DID of the electronic device 100. The DID included in the data certificate can be understood as data owner information. The electronic signature included in the data certificate can serve as a means of verification for the data owner. Anyone can obtain the public key associated with the DID through the DID document in the blockchain network 400 and verify the electronic signature based on the public key. A third party receiving the personal data and its data certificate can verify that it was directly transmitted by the owner of the personal data.

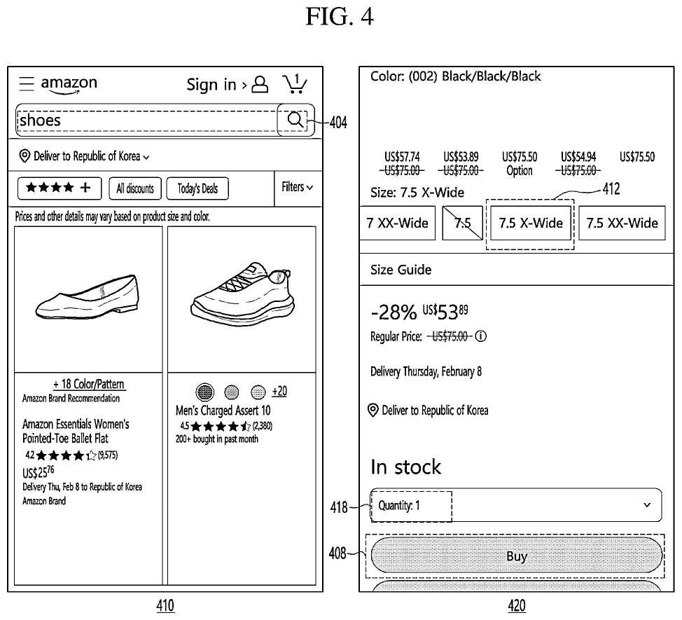

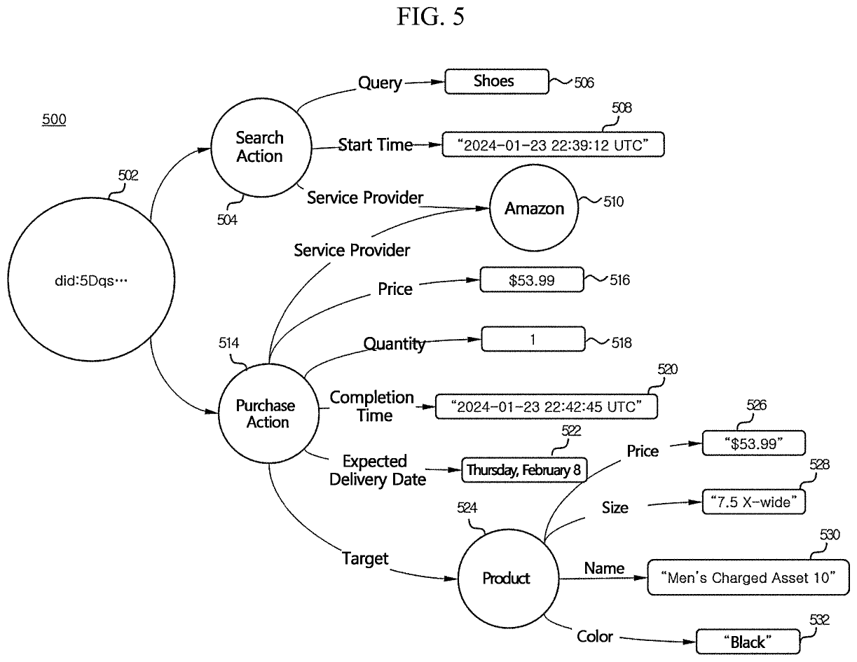

In operation 3070, when the electronic device 100 receives final data having the same format as the personal data from the AI language model 300, the electronic device 100 can merge and store the final data with the personal data already stored in the storage 180 of the electronic device 100 (3080). In various embodiments, the final data can have the same Personal Knowledge Graph (PKG) format as the personal data. In this case, the final data includes nodes and edges representing relationships between those nodes, and these nodes and edges can be understood as selected words from words included in the text data received from the multi-modal AI model 200 in operation 3050. An example of this is described later through FIGS. 4 and 5.

FIG. 4 is an example of screen image data captured by an electronic device 100. FIG. 5 is an example of personal data extracted from the screen image data captured in FIG. 4. The following describes an example of the process by which the electronic device 100 captures screen image data among user input/output data and extracts personal data from it through FIGS. 4 and 5.

Referring to FIG. 4, the target application is the shopping application Amazon, where the first screen image data 410 is understood to be captured when the target action of search is performed, and the second screen image data 420 is understood to be captured when the target action of purchase is performed.

Referring to the first screen image data 410, it can be understood that the target action of ‘search’ was performed. A keyboard input “shoes” was received in area 404 and touch input was received on the search button. For example, the electronic device 100 can capture the first screen image data 410 when touch input is received on the search button.

Referring to the second screen image data 420, it can be understood that the target action of ‘purchase’ was performed when touch input was received on the purchase button in area 408. The electronic device 100 can capture the second screen image data 410 when touch input is received on the purchase button. Although there were selection inputs for shoe size in area 412 and purchase quantity in area 414 of the second screen image data 420, since size and purchase quantity selection are not target actions, the electronic device 100 does not perform capture based on those selection inputs.

Once capture is complete, the electronic device 100 can transmit the first screen image data 410 and second screen image data 420 to the multi-modal AI model 200. For example, the electronic device 100 can generate an instruction including information that the target application “Amazon” was executed and target actions “search” and “purchase” were performed, and transmit the instruction, first screen image data 410, and second screen image data 420 to the multi-modal AI model 200. Additionally, to extract more accurate descriptive information, the electronic device 100 can transmit not only the first screen image data 410 but also keyboard input data generated when the search action was performed to the multi-modal AI model 200.

The electronic device 100 can receive text data describing the first screen image data 410 and second screen image data 420 from the multi-modal AI model 200. The electronic device 100 can transmit this text data to the language AI model 300 and receive structured personal data 500 as shown in FIG. 5 from the language AI model 300. Referring to FIG. 5, the personal data 500 is configured in PKG format. The personal data 500 may include nodes and edges. The edges represent relationships between the nodes.

The personal data 500 includes nodes 504 to 510 generated based on the search action and first screen image data 410. Data related to the search action (node 504) is structured and stored in personal data 500 as the search term (query) “shoes” (node 506), search start time and its value (node 508), and the action's service provider Amazon (node 510).

For example, the multi-modal AI model 200 can generate descriptive information in natural language form stating “The user performed a search action at 2024 Jan. 23 22:39:12 with ‘shoes’ as the query on Amazon, the service provider” for the first screen image data 410. The language AI model 300 can return personal data structured in PKG form (nodes 504, 506, 508, 510 of personal data 500) based on this descriptive information. For example, subjects and objects can be stored in nodes, and predicates representing the relationships between these subjects and objects can be stored in edges. The language AI model 400 extracts relationships between nodes from natural language sentences composed of text and constructs a graph.

The personal data 500 includes nodes 514 to 532 generated based on the purchase action and second screen image data 420. Since the search action (node 504) and purchase action (node 514) were performed from the same service provider, the service provider for the purchase action (node 514) is connected to the previously created Amazon (node 510). Information associated with the purchase action (node 514), such as price, quantity, purchase completion time, expected delivery date, and purchase target, is stored (nodes 516, 518, 520, 522, 524). The product as the purchase target (node 524) has detailed information including price, size, name, and color (nodes 526, 528, 530, 532).

According to various embodiments disclosed in this document, the electronic device 100 can be various types of devices. The electronic device 100 may include, for example, a portable communication device (e.g., smartphone), computer device, portable multimedia device, portable medical device, camera, wearable device, or home appliance. The electronic device 100 according to embodiments of this document is not limited to the aforementioned devices.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar or related reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). When a component (e.g., a first component) is referred to as being “coupled” or “connected” to another component (e.g., a second component), with or without the terms “functionally” or “communicatively,” it means that the component can be connected to the other component directly (e.g., wired), wirelessly, or through a third component.

Various embodiments as set forth herein may be implemented as software including one or more instructions that are stored in a storage medium that is readable by the electronic device 100. For example, a processor (e.g., the processor 110) of the electronic device 100 may invoke at least one of the one or more instructions stored in the storage medium, and execute the invoked instruction. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single subject or multiple subjects. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as those performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a memory for storing personal data; and
at least one processor,
wherein the at least one processor is configured to:
when detecting a target action during execution of a target application, capture user input/output data generated according to the target action,
transmit the user input/output data to a multi-modal AI model connected to the electronic device through a network,
receive text data generated based on the user input/output data from the multi-modal AI model,
transmit the text data to an AI language model connected to the electronic device,
receive final data having the same format as the personal data from the AI language model, and
merge and store the final data with the personal data.

2. The electronic device of claim 1, wherein the memory stores an operating system,
wherein the operating system includes a private key, public key, and a DID generated by the electronic device, which the private key and the public key are an account of a blockchain network,
wherein the at least one processor is configured to:
generate an electronic signature on the final data based on the private key, and generate a data certificate including the electronic signature and the DID.

3. The electronic device of claim 2, wherein the DID and information associated with the DID are stored in the blockchain network,
wherein the information associated with the DID includes manufacturer information of the electronic device.

4. The electronic device of claim 1, wherein the at least one processor is further configured to:
generate an instruction requesting a description of the user input/output data—wherein the instruction includes information about the target application and the target action,
and transmit the user input/output data and the instruction to the multi-modal AI model.

5. The electronic device of claim 1, wherein the final data has the same personal knowledge graph format as the personal data.

6. The electronic device of claim 5, wherein the final data includes nodes and edges which are relationships between the nodes,
wherein the nodes and the edges are words selected from words included in the text data.

7. The electronic device of claim 1, wherein the user input/output data is predetermined according to the target application and the target action among screen image data, screen video data, voice data, touch input data, and keyboard input data.

8. The electronic device of claim 7, wherein the at least one processor is further configured to:
capture the user input/output data at a predetermined time point or during a predetermined period for the target application and the target action.
